(19) United States
(12) Patent Application Publication
(10) Pub. No.: US 2013/0166555 A1
(43) Pub. Date: Jun. 27, 2013

(54) METHOD AND APPARATUS FOR MANAGING CONTACT DATA BY UTILIZING SOCIAL PROXIMITY INFORMATION

(71) Applicant: Matthias PFAFF, Berlin (DE)

(72) Inventor: Matthias PFAFF, Berlin (DE)

(73) Assignee: NOKIA CORPORATION, Espoo (FI)

(21) Appl. No.: 13/335,883

(22) Filed: Dec. 22, 2011

(51) Int. Cl. G06F 17/30

(52) U.S. Cl. 707/737; 707/736; 707/752; 707/E17.033

(57) ABSTRACT

An approach is provided for efficiently managing contact data in a phonebook by utilizing social proximity information at a device. An application and/or a widget processes and analyzes contact details associated with one or more contacts in order to determine a similarity to one or more other contact details associated with one or more users and/or one or more other contacts. Further, the application and/or the widget can determine one or more social proximity information items associated with the one or more contacts, the one or more users and/or the one or more other contacts and can utilize the social proximity information to manage (e.g., organize, group, sort, etc.) the contact data in the phonebook.

### BACKGROUND

Service providers (e.g., wireless, cellular, etc.) and device manufacturers are continually challenged to deliver value and convenience to consumers by, for example, providing compelling network services. One area of interest has been utilization of mobile devices (e.g., smartphones) by users to collect, store and manage data related to the users' contacts (e.g., in an electronic phonebook) wherein each contact's data can include one or more phone numbers, location addresses, email addresses, employment company information, social network information and the like. Further, the contacts can be arranged into various groups based on the relationship to the user (e.g., family, friends, colleagues, etc.) wherein each group may have further information and rules associated with the group. However, as the number of entries/contacts in a phonebook on a user device increases, so does the complexity of the task for managing and organizing the contact list and groups. This increased complexity, has created a need to improve the handling of phonebook entries in mobile devices. Accordingly, service providers and device manufacturers face significant technical challenges for enabling applications and services that efficiently manage and organize contact data in a phonebook on a user device.

### SOME EXAMPLE EMBODIMENTS

Therefore, there is a need for an approach for efficiently managing contact data in a device by utilizing social proximity information.

According to one embodiment, a method comprises processing and/or facilitating a processing of one or more contact details associated with one or more contacts to determine a similarity to one or more other contact details associated with one or more users, one or more other contacts, or a combination thereof. The method also comprises determining social proximity information associated with the one or more contacts, the one or more users, the one or more other contacts, or a combination thereof

According to another embodiment, an apparatus comprising at least one processor, and at least one memory including computer program code, the at least one memory and the computer program code configured to, with the at least one processor, cause the apparatus to process and/or facilitate a processing of one or more contact details associated with one or more contacts to determine a similarity to one or more other contact details associated with one or more users, one or more other contacts, or a combination thereof The apparatus is also caused to determine social proximity information associated with the one or more contacts, the one or more users, the one or more other contacts, or a combination thereof

According to another embodiment, a computer-readable storage medium carrying one or more sequences of one or more instructions which, when executed by one or more processors, cause, at least in part, an apparatus to process and/or facilitate a processing of one or more contact details associated with one or more contacts to determine a similarity to one or more other contact details associated with one or more users, one or more other contacts, or a combination thereof The apparatus is also caused to determine social proximity information associated with the one or more contacts, the one or more users, the one or more other contacts, or a combination thereof.

According to another embodiment, an apparatus comprises means for processing and/or facilitating a processing of one or more contact details associated with one or more contacts to determine a similarity to one or more other contact details associated with one or more users, one or more other contacts, or a combination thereof. The apparatus also comprises means for determining social proximity information associated with the one or more contacts, the one or more users, the one or more other contacts, or a combination thereof

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of efficiently managing contact data in a phonebook by utilizing social proximity information at a user device, according to one embodiment;

FIG. 2 is a diagram of the components of a user equipment capable of efficiently managing contact data in a phonebook by utilizing social proximity information, according to one embodiment;

FIG. 3 is a flowchart for determining and/or processing one or more contact details, according to one embodiment;

FIG. 4 is a flowchart of a process for determining a grouping of one or more contacts, according to one embodiment;

FIGS. 5A-5E are diagrams of various user interfaces in a phonebook application, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for efficiently managing contact data in a device by utilizing social proximity information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

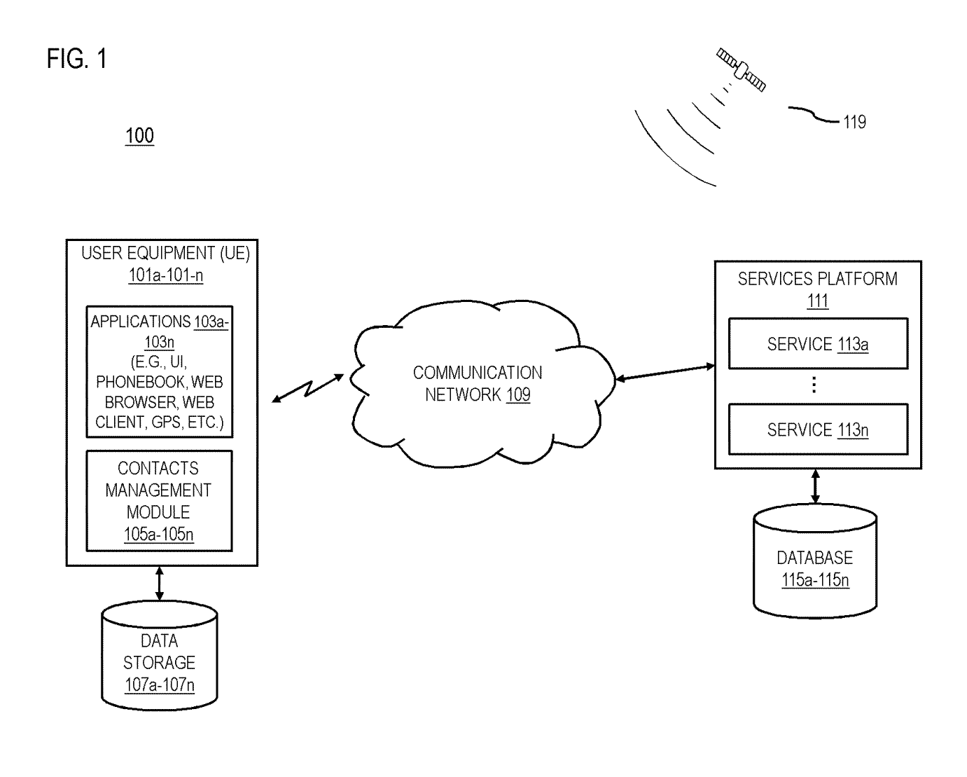

FIG. 1 is a diagram of a system capable of efficiently managing contact data in a phonebook by utilizing social proximity information, according to one embodiment. In various examples, the social proximity information can indicate different social proximity/relationships between people/users; for example, to indicate as friends, family, neighbors, colleagues, classmates, and the like, wherein the social proximity may be determined by the user, one or more service providers and/or one or more applications on a user device. For example, a user may choose to determine social proximity between the user and other users/contacts in the user's phonebook. In another example, one or more service providers may determine one or more relationships between the user and one or more other users/contacts by monitoring and analyzing communication methods, frequency, timing and the like between the user and the other users. In another example, one or more information items associated with the user and one or more other users associated with the user may be utilized to determine one or more relationships between the user and the other users. Generally, it is becoming increasingly popular for users to utilize a phonebook application on a user device (e.g., a mobile phone, a tablet, a PDA, etc.) to store, manage and utilize one or more contact information wherein the phonebook may comprise a plurality of contact entries where each of the contact entries may include various information items associated with the contact (e.g., one or more names, phone numbers, email addresses, location addresses, social network information, etc.). Generally, over time, a user may populate the phonebook with the contact data and further associate each contact/entry with one or more rules and/or groups. Additionally, the user may have different types of relationships or social proximities (e.g., friends, family, classmates, colleagues, etc.) with each listed contact and/or the contacts may have different relationships with one another (e.g., two listed contacts are brothers; two other listed contacts are classmates of each other, etc.). Furthermore, the relevancy may be associated with a group of people which may be determined by comparing their social proximity information with each contact's attributes and/or with the user's own attributes. For example, a listed contact having a location address on the same street as the user can be listed in a “Neighbor” group in the phonebook. However, as the number of contacts and associated information in a phonebook increases, managing and organizing the contacts and their associated information in the phonebook can become increasingly more complex and difficult for a user to accomplish substantially manually.

Therefore, service providers and device manufacturers face the problem of providing a solution for efficiently managing contact data in a phonebook by utilizing social proximity information.

To address this problem, a system 100 of FIG. 1 introduces the capability of efficiently managing contact data in a phonebook by, for instance, processing commonly stored contact information to determine social proximity among a user and the user's contact entries. In other words, the system 100 applies social proximity mining techniques to determine social proximity or relationships among people (e.g., based on common last names, common neighborhoods, common work emails, etc.) without direct intervention from a user. In this way, the system 100 enables, for instance, applications and/or services to leverage the social proximity information to tailor functions, content, etc. (e.g., automatically creating contact groups, recommending friends, etc.) without requiring users to provide such information directly.

In one scenario, a user of a user device (e.g., a mobile phone) and/or a service provider creates a user profile card (e.g., user information, ID, etc.), which may be associated with one or more user devices, wherein the user profile may be stored locally at one or more user devices and/or remotely at one or more service provider devices. Further, the user may utilize a phonebook application/widget to create and store one or more contacts comprising one or more information items (e.g., phone numbers, names, addresses, emails, etc.) wherein the one or more information items of the one or more contacts are compared with the user's information (e.g., profile card) and/or are compared with one or more other contacts' information. Furthermore, each time there is a new contact entry into the phonebook and/or there is an update to the user's and/or to the contacts' information, the comparisons are performed. Moreover, the system 100 can perform one or more preset information/data comparisons which may be editable by the user such that one or more alternatives to the parameters and/or results of the comparison (e.g., another last name or maiden name of a spouse/partner) can be taken into consideration. Implementation of such mechanism can provide improved and automated assistance to the user for making a phonebook/contact-book of a mobile device more useful, for example, by prioritizing the contacts in the phonebook, smart grouping, creating a hierarchy and utilizing social proximity information as an improvement in accessing those contacts.

For example, a contacts management module (CMM) on a user device and/or at a services platform may execute one or more algorithms to determine social proximity between one or more contacts and/or between the one or more contacts and the user of the user device. Additionally, the CMM can assign the one or more contacts to one or more groups in the phonebook wherein the one or more contacts and/or the one or more groups can then be assigned different grades/levels of social proximity. For example, contacts having the same business e-mail URL (uniform resource locator) can potentially indicate that those contacts may be colleagues. In another example, contacts having the same last name may be members of the same family. In another example, the CMM can determine one or more updates to information and/or rules of one or more users, contacts and/or groups within the phonebook and then can utilize the update information to further update information and/or rules of one or more other users, other contacts and/or other groups within the phonebook. In another example, the CMM can associate one or more rules with one or more contacts and/or one or more groups such as birthday reminders, special occasion reminders (e.g., an anniversary) and the like, wherein the one or more rules can further be customized for each contact and/or group, for example, a reminder for a spouse's birthday can be presented several times within 30 days of the birthday whereas a reminder for a friend's birthday can be presented twice within one week of the birthday. It is noted that the CMM may be partially or completely implemented at a user device and/or at one or more services platform; further, the contact data/information may be stored at a local storage on the user device and/or at one or more remote storage devices (e.g., servers) at the one or more services platform (e.g., web based, cloud computing, etc.). In another example, contact with same street address can be assigned to a “Neighbor Group.” In other scenarios, depending on which data item of a contact is edited, “smart groups” may be auto-populated with contact data from the phonebook. In another scenario, one or more rules can determine how and when any of the contacts in the phonebook may be able to communicate with the user; for example, communications from members of the “Family Group” may be presented to the user no matter what user status the phone may indicate (e.g., in a meeting, busy, do not disturb, etc.). In another example, one or more rules may indicate if when and/or how user location is shared with one or more contacts in one or more groups.

In one embodiment, the CMM processes and/or facilitates a processing of one or more contact details associated with one or more contacts to determine a similarity to one or more other contact details associated with one or more users, one or more other contacts, or a combination thereof wherein the one or more contact details include, at least in part, a contact name, an address, a phone number, an electronic mail address, a social network name, or a combination thereof. For example, the user receives and/or enters information for a new contact in the phonebook and the CMM processes/analyses/compares the information to the user's information (e.g., in the user's profile) and/or to one or more other contacts' information already available in the phonebook in order to determine any similarities between the information of the new contact and that of the user's and/or the other contacts. Further, the CMM determines one or more social proximity information associated with the one or more contacts, the one or more users, the one or more other contacts, or a combination thereof For example, the contact information of the user and/or the one or more contacts can comprise one or more social proximity information which may include a name, phone number, location address, employer, email address URL and the like. In one embodiment, the social proximity information may be available at a user device and/or at one or more service platform.

In another embodiment, the one or more contacts may be organized into one or more groups based, at least in part, on the social proximity information associated with the one or more contacts. In various embodiments, the one or more groups include, at least in part, one or more family groups, one or more colleague groups, one or more neighbor groups, or a combination thereof. For example, the one or more groups (e.g., family, friends, colleagues, clients, classmates, students, etc.) may be created by the user and/or the CMM based on one or more rules and/or based on one or more social proximity information associated with each user such as location address, email address, phone number area code, employer, city, etc.

In various embodiments one or more rules are associated with the one or more groups, wherein the one or more rules operate on the one or more contacts in the one or more groups. Further, the one or more rules relate, at least in part, to one or more notification settings, one or more reminder preferences, one or more availability statuses, one or more information sharing preferences, or a combination thereof For example, a rule associated with the “Family” group can notify the user (e.g., via a calendar application, via SMS, via pop-up reminders, etc.) of any birthdays associated with the contacts listed in the “Family” group. In another example, a rule associated with the “Friends” group can cause an email/SMS notification to be sent to the group at the end of each month for a social gathering of the contacts listed in the “Friends” group.

In another embodiment, the CMM determines one or more updates of the one or more contact details, the one or more contacts, the one or more other contact details, the one or more users, the one or more other contacts, or a combination thereof. For example, a user and/or a service provider can update and/or cause one or more updates to one or more information items associated with one or more contacts, one or more users, one or more groups, one or more rules and the like. In another embodiment, the one or more updates may cause, at least in part, an initiation of the determining of the social proximity information. For example, if a location address of a contact is updated, then the CMM may compare the updated address to that of the user's (e.g., in the user's profile) and/or to that of the one or more other contacts in the phonebook. In another example, an update to one or more rules associated with the phonebook may cause a comparison of the update with one or more rules associated with one or more contacts and/or one or more groups within the phonebook.

In another embodiment, the one or more contacts may be prioritized, sorted, ordered and the like based, at least in part, on the social proximity information. For example, a contact listed in the “Family” group may be assigned a higher priority for communicating with the user such that any communications from the contact associated the “Family” group will be immediately presented/communicated to the user. In another example, those contacts having the same street name in their location address are listed, at least, in a “Neighbor” group. In another example, contacts listed in the “Neighbor” group are sorted by the residence number compared to that of the user's residence number (e.g., proximity of the neighbor's residence to the user's residence). In another embodiment, hierarchy of the one or more contacts is determined based, at least in part, on the social proximity information. For example, contacts in the “Family” group having the same location address (e.g., spouse/children/user having the same address) are listed first in the “Family Group.” In another embodiment, a contact in a “Friends” list who is a member of the same social networking network as the user is listed at the top of the list.

In another embodiment, at least a portion of the one or more other contact details may be appended with at least another portion of the one or more contact details based, at least in part, on the social proximity information. For example, a user may wish to add a new contact (e.g., a new neighbor) to the phonebook wherein the CMM compares one or more contact details being entered (e.g., street name) to one or more other contacts' details already in the phonebook and if a match is found (e.g., the new neighbor's address has the same street name as another contact/neighbor in the phonebook), then one or more portions of the new contact details (e.g., city, zip code, state, telephone area code, etc.) can be retrieved from details of one or more other contacts (e.g., another contact having the same street name as the new contact) in the phonebook.

As shown in FIG. 1, the system 100 comprises one or more user equipment (UE) 101a-101n (also collectively referred to as UE 101) having connectivity to services platform 111, which may comprise one or more service providers 113a-113n, via a communication network 109. By way of example, the communication network 109 of system 100 includes one or more networks such as a data network, a wireless network, a telephony network, or any combination thereof It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the services platform 111 may receive, obtain and/or manage information related to one or more contacts in a phonebook wherein the information may be stored locally and/or remotely at one or more database 115a-115n (also collectively referred to database 115). The database 115 can include identifiers to each UE 101 as well as associated user information (e.g., user profile). Further, the information may be any one of multiple types of information that can provide means for creating a rendering of the information in a contact-based user interface (e.g., a phonebook). The contact information at database 115 may be collected from one or more users and/or one or more other sources (e.g., web services, web servers, social networking services, public databases, etc.) available via the communication network 109.

In one embodiment, the UI application 103 is a contact-based application. For instance, the contact-based UI may be a phonebook on the UE 101. The contact-based UI may also be the integration of several contact-based applications, such as a compiled listing comprised of entries in a device phonebook and various social networking service entries.

Further, as the information in the data storage 107 and/or the database 115 may be changed by the user of the UE 101 and/or by one or more information providing sources at the services platform 111, the CMM 105 monitors the data storage 107 and/or the database 115 for any changes and once it detects one or more changes, it executes one or more algorithms to analyze the changes and ascertain if information associated with one or more contacts and/or the user should be changed/updated as well. In one embodiment, the user may run one or more applications 103 to update/modify one or more information associated with the user and/or with one or more contacts in a phonebook on a user device and/or at the services platform 111.

In various embodiments, a user, one or more service providers and/or one or more applications on the UE 101 may utilize the social proximity information associated with the user and the one or more contacts in the user phonebook to determine sharing of one or more user information items with the one or more contacts. For example, a user may wish to continuously share location information (e.g., based on GPS information) of the user with family members listed in an “Immediate Family Members” group in the phonebook whereas sharing of the location information with other members and other groups would be restricted with one or more other rules applied to them. In another example, location information of the user may be shared with members of a “Colleagues” group during normal business hours and while the user is located at or close to business location of the user. In another embodiment, the user may determine one or more rules that apply to one or more groups at certain occasions such as when travelling, when the user is outside of user's normal time zone, when at an airport, and the like. For example, a user may wish to notify his friends that he is on business travel and cannot chat on personal calls during that time.

By way of example, the UE 101 and services platform 111 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

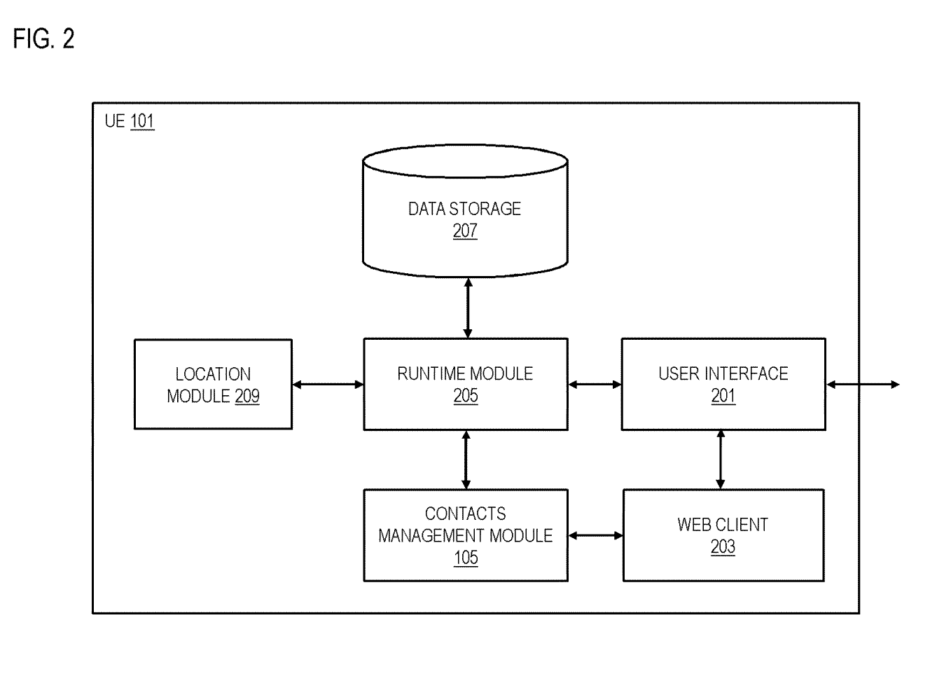

FIG. 2 is a diagram of the components of a user equipment capable of managing contact data in a phonebook by utilizing social proximity information, according to one embodiment. By way of example, the UE 101 includes one or more components for managing contact data in a device by utilizing social proximity information as discussed in various embodiments of the approach described herein. It is contemplated that the functions of these components may be combined in one or more components or performed by other components of equivalent functionality. In this embodiment, the UE 101 includes a user interface 201 to present one or more applications to the user and provide one or more mechanisms for user input; a web client 203 to receive one or more information items from the services platform 111 and/or execute one or more web-based applications and/or algorithms; ; a runtime module 205 for executing one or more applications (e.g., a phonebook 103, a UI 103, navigation application 103, web client application 103, etc.); a data storage 207 to locally store one or more contact and/or user information; a location module 209 to determine a location of the UE 101; a contacts management module (CMM) 105 to manage one or more contact lists and information associated with the one or more contacts. In various embodiment, the CMM 105 can, at least in part, analyze any changes and/or updates to any information at the data storage 107 and/or database 115 which are associated with one or more contacts and/or one or more users of UE 101 wherein the CMM 105 may execute one or more algorithms to perform the one or more said tasks. Further, the algorithms may reside at the UE 101 and/or may be web-based (e.g., java script).

In one embodiment, the location module 209 can determine a user's location. The user's location can be determined by a triangulation system such as a global positioning system (GPS), assisted GPS (A-GPS), Cell of Origin, wireless local area network triangulation, or other location extrapolation technologies. Standard GPS and A-GPS systems can use satellites 119 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 209 may also utilize multiple technologies to detect the location of the UE 101. GPS coordinates can provide finer detail as to the location of the UE 101. As previously noted, the location module 209 may be utilized to determine location coordinates for use by the application 103.

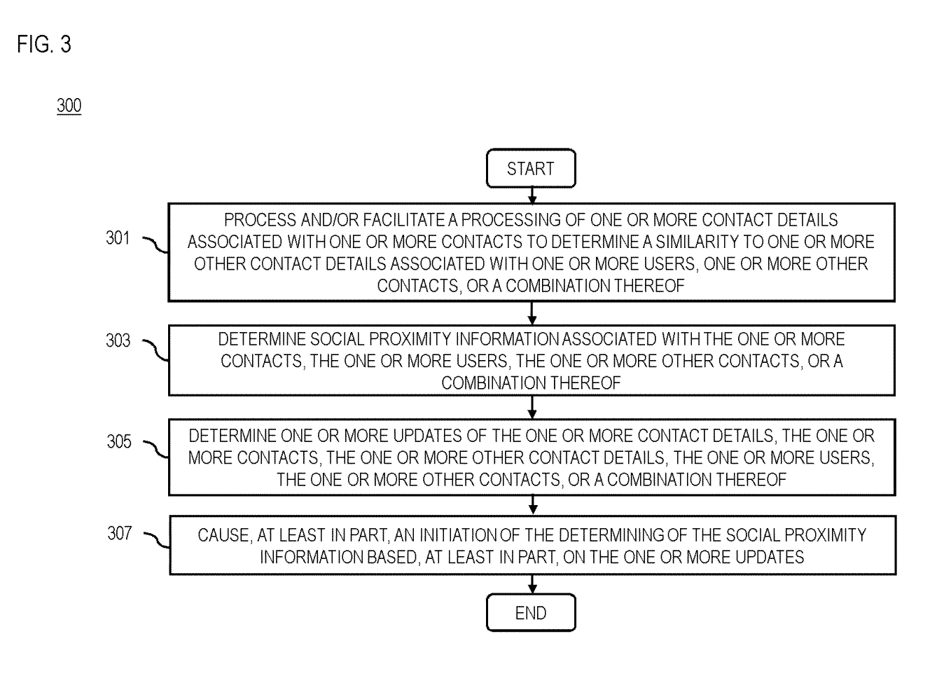

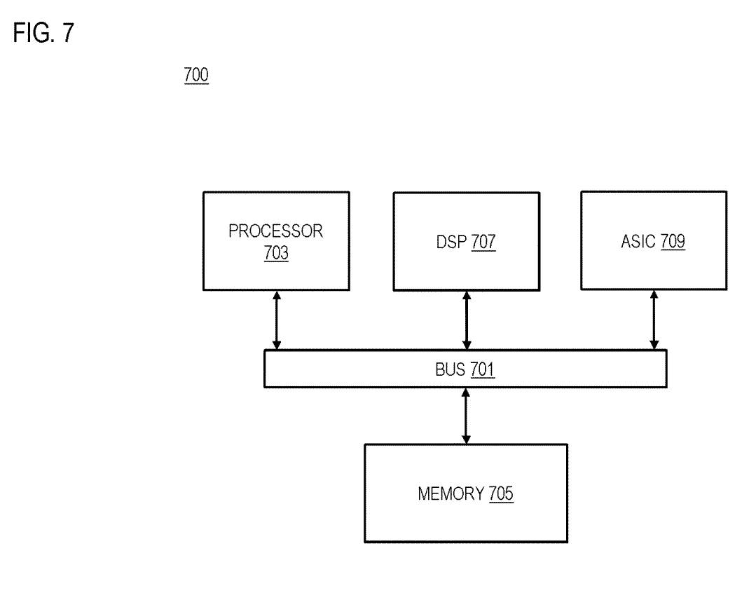

FIG. 3 is a flowchart of a process for determining and/or processing one or more contact details, according to one embodiment. In various embodiments, the runtime module 205 and/or the services platform 111 perform all or parts of the process 300 and are implemented in, for instance, a chip set including a processor and a memory as shown FIG. 7. In certain embodiments, the services platform 111 may perform some or all of the steps of the process 300 and communicate with the UE 101 using a client server interface. For example, the UE 101 may activate applications 103 and/or CMM 105 for determining and/or processing one or more contact details associated with one or more phonebooks on a device. Moreover, the applications 103 may execute upon the runtime module 205.

In step 301, the CMM 105 and/or the services platform 111 processes and/or facilitates a processing of one or more contact details associated with one or more contacts to determine a similarity to one or more other contact details associated with one or more users, one or more other contacts, or a combination thereof wherein the one or more contact details include, at least in part, a contact name, an address, a phone number, an electronic mail address, a social network name, or a combination thereof. For example, the user receives and/or enters information for a new contact in the phonebook and the CMM processes/analyses/compares the information to the user's information (e.g., in the user's profile) and/or to one or more other contacts' information already available in the phonebook in order to determine any similarities between the information of the new contact and that of the user's and/or the other contacts.

In step 303, the CMM 105 determines one or more social proximity information associated with the one or more contacts, the one or more users, the one or more other contacts, or a combination thereof For example, the contact information of the user and/or the one or more contacts can comprise one or more social proximity information which may include a name, phone number, location address, employer, email address URL and the like. In one embodiment, the social proximity information may be available at a user device and/or at one or more service platform.

In another embodiment, the one or more contacts may be organized into one or more groups based, at least in part, on the social proximity information associated with the one or more contacts. In various embodiments, the one or more groups include, at least in part, one or more family groups, one or more colleague groups, one or more neighbor groups, or a combination thereof For example, the one or more groups (e.g., family, friends, colleagues, clients, classmates, students, etc.) may be created by the user and/or the CMM based on one or more rules and/or based on one or more social proximity information associated with each user such as location address, email address, phone number area code, employer, city, etc.

In various embodiments, one or more rules are associated with the one or more groups, wherein the one or more rules operate on the one or more contacts in the one or more groups. Further, the one or more rules relate, at least in part, to one or more notification settings, one or more reminder preferences, one or more availability statuses, one or more information sharing preferences, or a combination thereof For example, a rule associated with the “Family” group can notify the user (e.g., via a calendar application, via SMS, via pop-up reminders, etc.) of any birthdays associated with the contacts listed in the “Family” group. In another example, a rule associated with the “Friends” group can cause an email/SMS notification to be sent to the group at the end of each month for a social gathering of the contacts listed in the “Friends” group.

In step 305, the CMM 105 determines one or more updates of the one or more contact details, the one or more contacts, the one or more other contact details, the one or more users, the one or more other contacts, or a combination thereof For example, a user and/or a service provider can update and/or cause one or more updates to one or more information items associated with one or more contacts, one or more users, one or more groups, one or more rules and the like.

In step 307, the CMM 105 causes, at least in part, an initiation of the determining of the social proximity information based, at least in part, on the one or more updates. For example, if a location address of a contact is updated, then the CMM may compare the updated address to that of the user's (e.g., in the user's profile) and/or to that of the one or more other contacts in the phonebook. In another example, an update to one or more rules associated with the phonebook may cause a comparison of the update with one or more rules associated with one or more contacts and/or one or more groups within the phonebook.

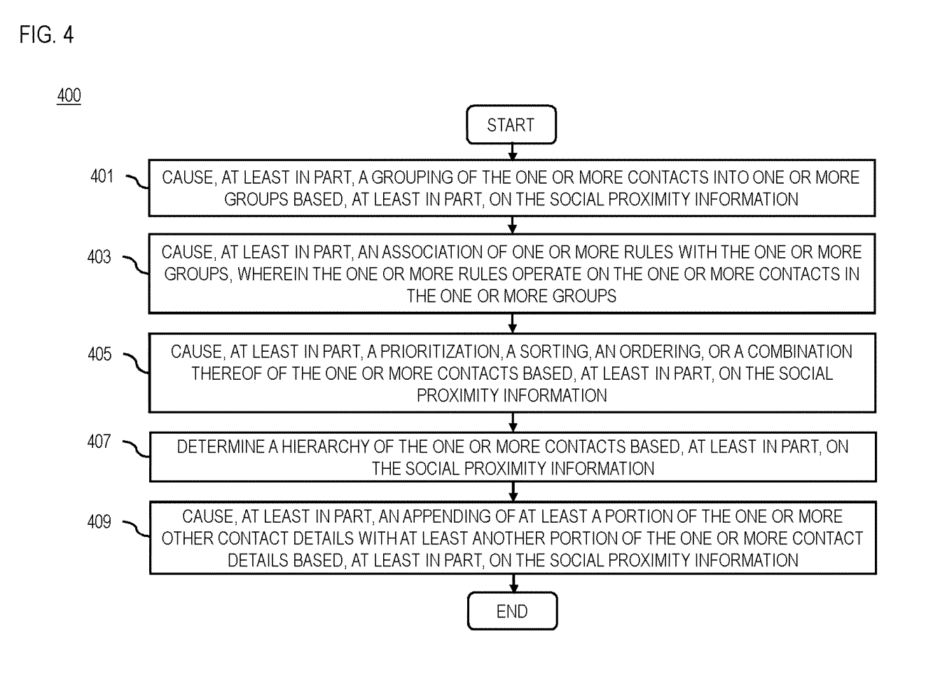

FIG. 4 is a flowchart of a process for determining a grouping of one or more contacts, according to one embodiment. In various embodiments, the runtime module 205 and/or the services platform 111 perform all or parts of the process 400 and are implemented in, for instance, a chip set including a processor and a memory as shown FIG. 7. In certain embodiments, the services platform 111 may perform some or all of the steps of the process 300 and communicate with the UE 101 using a client server interface. For example, the UE 101 may activate applications 103 and/or CMM 105 for determining and/or processing one or more contact details associated with one or more phonebooks on a device. Moreover, the applications 103 may execute upon the runtime module 205.

In step 401, the CMM 105 and/or the services platform 111 cause, at least in part, a grouping of the one or more contacts into one or more groups based, at least in part, on the social proximity information. In various embodiments, the one or more groups include, at least in part, one or more family groups, one or more colleague groups, one or more neighbor groups, or a combination thereof. For example, the one or more groups (e.g., family, friends, colleagues, clients, classmates, students, etc.) may be created by the user and/or the CMM based on one or more rules and/or based on one or more social proximity information associated with each user such as location address, email address, phone number area code, employer, city, etc.

In step 403, the CMM 105 and/or the services platform 111 cause, at least in part, an association of one or more rules with the one or more groups, wherein the one or more rules operate on the one or more contacts in the one or more groups. Further, the one or more rules relate, at least in part, to one or more notification settings, one or more reminder preferences, one or more availability statuses, one or more information sharing preferences, or a combination thereof. For example, a rule associated with the “Family” group can notify the user (e.g., via a calendar application, via SMS, via pop-up reminders, etc.) of any birthdays associated with the contacts listed in the “Family” group. In another example, a rule associated with the “Friends” group can cause an email/SMS notification to be sent to the group at the end of each month for a social gathering of the contacts listed in the “Friends” group.

In step 405, the CMM 105 causes, at least in part, a prioritization, a sorting, an ordering, or a combination thereof of the one or more contacts based, at least in part, on the social proximity information. For example, a contact listed in the “Family” group may be assigned a higher priority for communicating with the user such that any communications from the contact associated the “Family” group will be immediately presented/communicated to the user. In another example, those contacts having the same street name in their location address are listed, at least, in a “Neighbor” group. In another example, contacts listed in the “Neighbor” group are sorted by the residence number compared to that of the user's residence number (e.g., proximity of the neighbor's residence to the user's residence).

In step 407, the CMM 105 determines a hierarchy of the one or more contacts based, at least in part, on the social proximity information. For example, contacts in the “Family” group having the same location address (e.g., spouse/children/user having the same address) are listed first in the “Family” group. In another embodiment, a contact in a “Friends” list who is a member of the same social networking network as the user is listed on top of the list.

In step 409, the CMM 105 causes, at least in part, an appending of at least a portion of the one or more other contact details with at least another portion of the one or more contact details based, at least in part, on the social proximity information. For example, a user may wish to add a new contact (e.g., a new neighbor) to the phonebook wherein the CMM 105 compares one or more contact details being entered (e.g., street name) to one or more other contacts' details already in the phonebook and if a match is found (e.g., the new neighbor's address has the same street name as another contact/neighbor in the phonebook), then one or more portions of the new contact details (e.g., city, zip code, state, telephone area code, etc.) can be retrieved from details of one or more other contacts (e.g., another contact having the same street name as the new contact) in the phonebook.

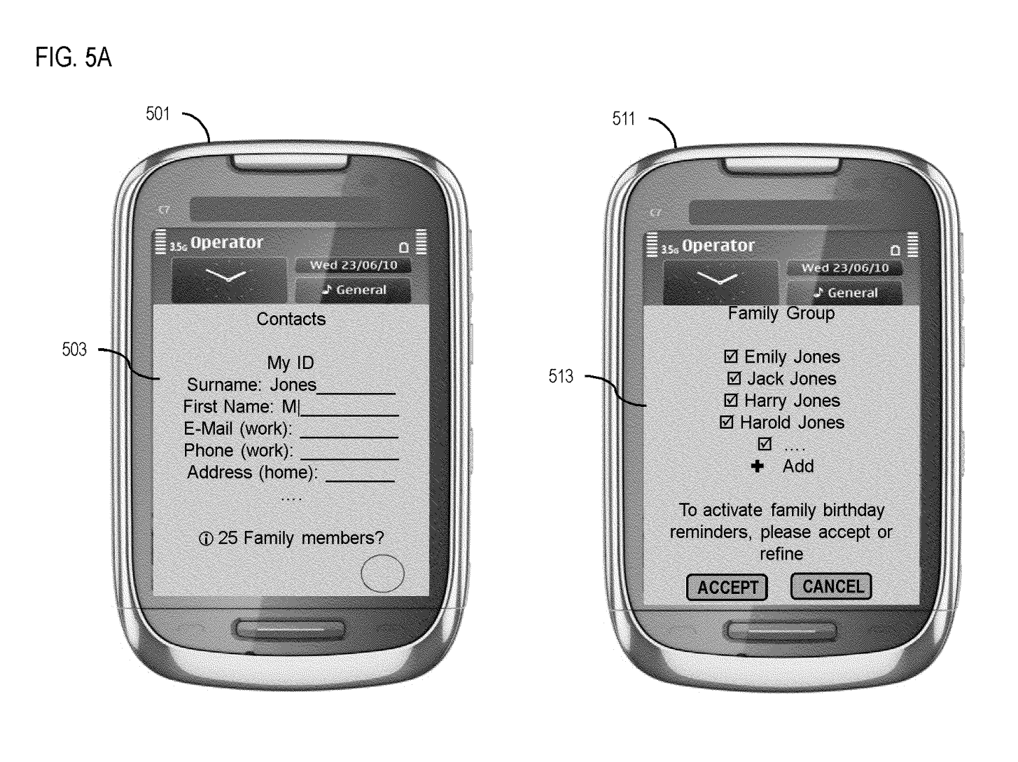

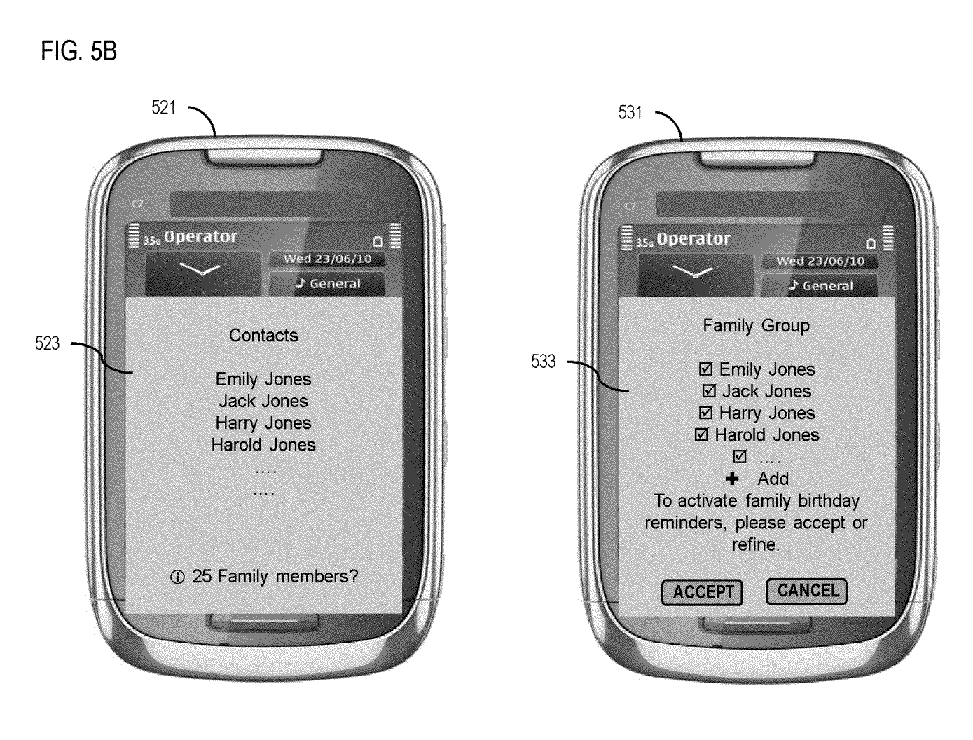

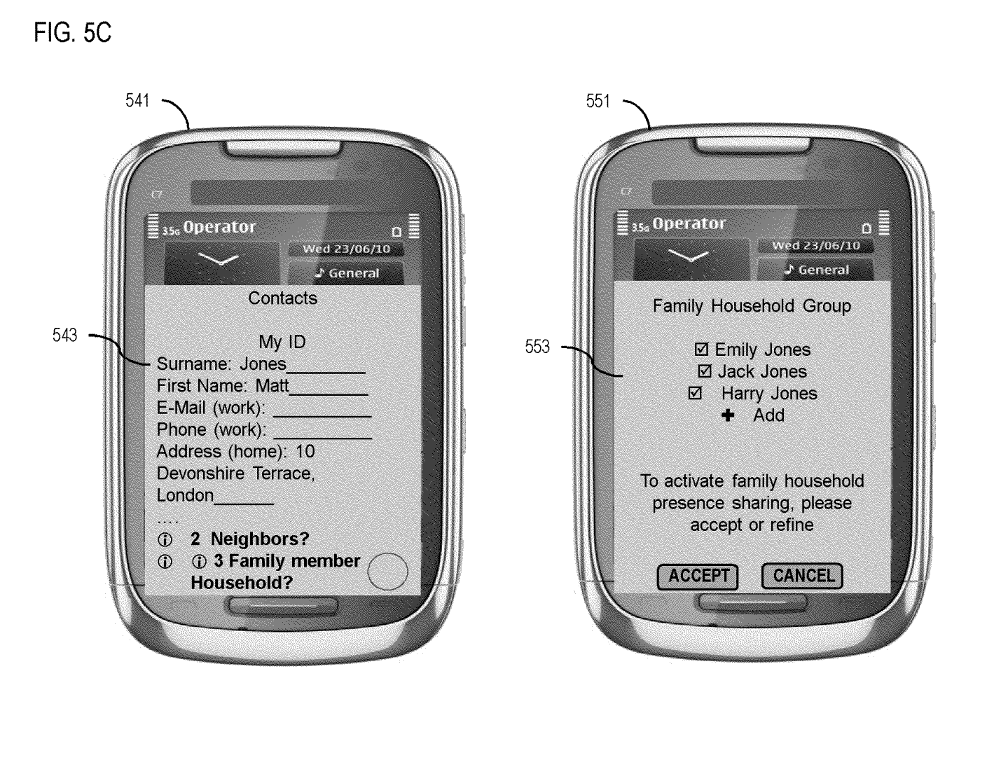

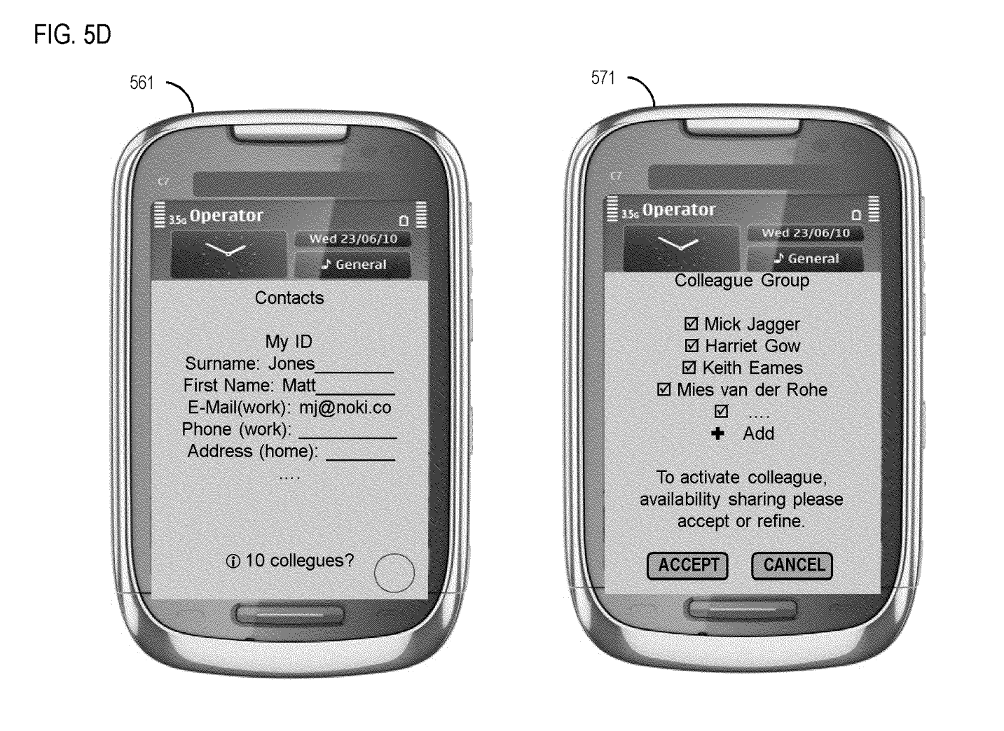

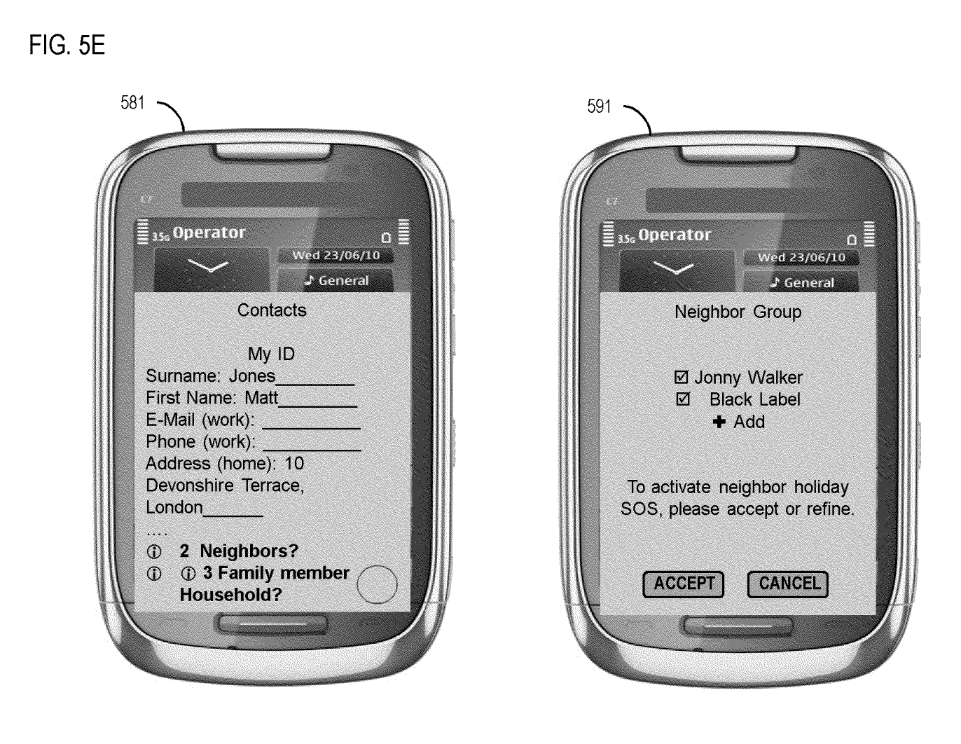

FIGS. 5A-5E are diagrams of various user interfaces in a phonebook application, according to various embodiments. FIG. 5A shows UI renderings 501 and 511. In one embodiment, a user updates one or more information items in 503 associated with the user, which, at least in part, causes a prompt in UI 511 for the user to select from one or more options in 513. For example, one or more rules may be executed to update and/or set one or more rules, reminders, suggestions (e.g., a birthday reminder) associated with a “Family Group.”

FIG. 5B shows UI renderings 521 and 531. In one embodiment, a user and/or an application receives and/or imports one or more information items associated with one or more contacts in 523 wherein the one or more received and/or imported information items are compared with that of the user and/or of one or more other contacts so that one or more rules may be applied to the received and/or imported information items.

FIG. 5C shows UI renderings 541 and 551. In one embodiment, a user and/or applications 103 in 541 may update one or more information items in 543 related with the user location address, which causes the CMM 105 in 551 to compare the updated user location address with that of one or more contacts 553 so that one or more rules and/or one or more groups may be presented/suggested to the user. For example, if a spouse changes his location address in the phonebook and/or in a user ID card, then the CMM 105 may substantially automatically update the location address for the members of the “Family Household Group”.

FIG. 5D shows UI renderings 561 and 571. In one embodiment, updating and/or addition of an email address in 561 to the user's and/or to one or more user contact information causes the CMM 105 to compare and update in 571 a “Colleague Group”. For example, one or more users' email addresses having the same domain name (e.g., user@DOMAINEXAMPLE.com) as that of the user's are added to the “Colleague Group.”

FIG. 5E shows UI renderings 581 and 591. In one embodiment, an update to location address of the user causes the CMM 105 to compare the updated location address to location addresses of one or more other users. For example, the comparison may indicate that there are one or more contacts in the phonebook that may be added to a “Neighbor Group” in the phonebook.

The processes described herein for efficiently managing contact data in a phonebook by utilizing social proximity information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

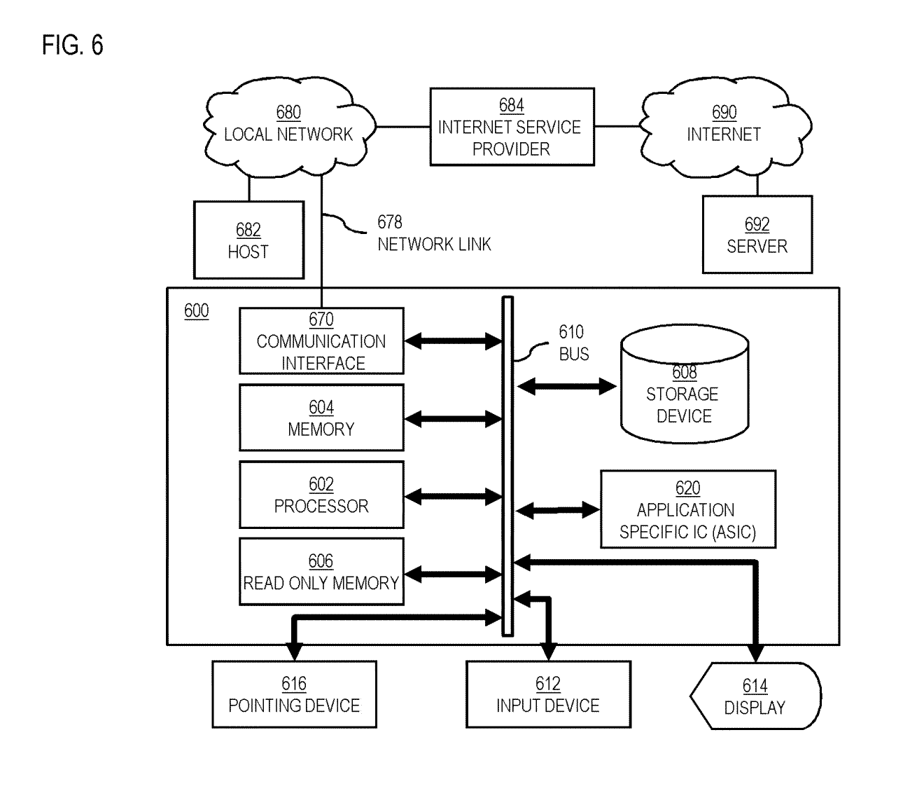

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to efficiently manage contact data in a phonebook by utilizing social proximity information as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of efficiently managing contact data in a phonebook by utilizing social proximity information. A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to efficiently manage contact data in a phonebook by utilizing social proximity information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for efficiently managing contact data in a phonebook by utilizing social proximity information. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for efficiently managing contact data in a phonebook by utilizing social proximity information is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 109 to efficiently manage contact data in a phonebook by utilizing social proximity information.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to efficiently manage contact data in a phonebook by utilizing social proximity information as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of efficiently managing contact data in a phonebook by utilizing social proximity information.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to efficiently manage contact data in a phonebook by utilizing social proximity information. The memory 705 also stores the data associated with or generated by the execution of the inventive steps.

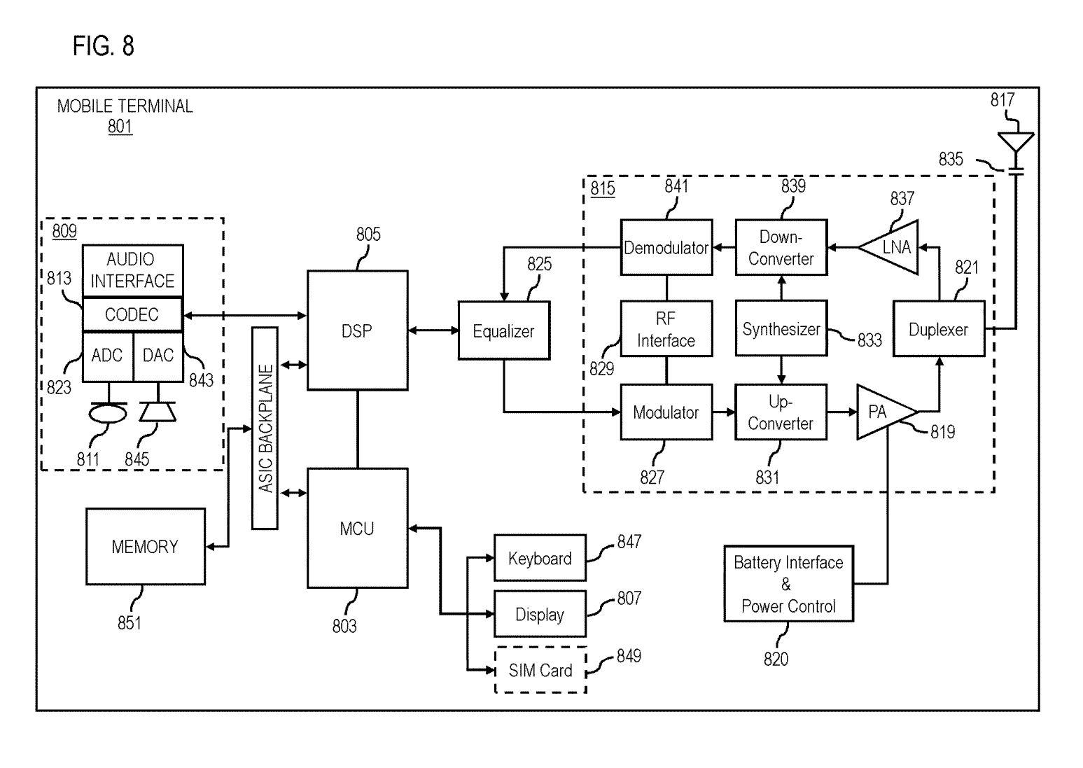

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for efficiently managing contact data in a phonebook by utilizing social proximity information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of efficiently managing contact data in a phonebook by utilizing social proximity information. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to efficiently manage contact data in a phonebook by utilizing social proximity information. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method for managing contact data in a phonebook, comprising:
processing, via one or more processors, one or more contact details associated with one or more contacts to determine a similarity to one or more other contact details associated with one or more users, one or more other contacts, or a combination thereof;
determining social proximity information associated with the one or more contacts, the one or more users, the one or more other contacts, or a combination thereof; and
utilizing the social proximity information to manage the contact data in the phonebook.

2. A method of claim 1, further comprising:
determining one or more updates of the one or more contact details, the one or more contacts, the one or more other contact details, the one or more users, the one or more other contacts, or a combination thereof; and
initiating the determining of the social proximity information based, at least in part, on the one or more updates.

3. A method of claim 1, further comprising:
grouping the one or more contacts into one or more groups based, at least in part, on the social proximity information.

4. A method of claim 3, further comprising
associating one or more rules with the one or more groups,
wherein the one or more rules operate on the one or more contacts in the one or more groups.

5. A method of claim 4, wherein the one or more rules relate, at least in part, to one or more notification settings, one or more reminder preferences, one or more availability statuses, one or more information sharing preferences, or a combination thereof.

6. A method of claim 3, wherein the one or more groups include, at least in part, one or more family groups, one or more colleague groups, one or more neighbor groups, or a combination thereof.

7. A method of claim 1, further comprising:
prioritizing, sorting, ordering, or a combination thereof, the one or more contacts based, at least in part, on the social proximity information.

8. A method of claim 1, further comprising:
determining a hierarchy of the one or more contacts based, at least in part, on the social proximity information.

9. A method of claim 1, wherein the one or more contact details include, at least in part, a contact name, an address, a phone number, an electronic mail address, a social network name, or a combination thereof

10. A method of claim 1, further comprising:
appending at least a portion of the one or more other contact details with at least another portion of the one or more contact details based, at least in part, on the social proximity information.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more contact details associated with one or more contacts in a phonebook to determine a similarity to one or more other contact details associated with one or more users, one or more other contacts, or a combination thereof;
determine social proximity information associated with the one or more contacts, the one or more users, the one or more other contacts, or a combination thereof; and
utilize the social proximity information to manage the contacts in the phonebook.

12. An apparatus of claim 11, wherein the apparatus is further caused to:
determine one or more updates of the one or more contact details, the one or more contacts, the one or more other contact details, the one or more users, the one or more other contacts, or a combination thereof; and
cause, at least in part, an initiation of the determining of the social proximity information based, at least in part, on the one or more updates.

13. An apparatus of claim 11, wherein the apparatus is further caused to:
cause, at least in part, a grouping of the one or more contacts into one or more groups based, at least in part, on the social proximity information.

14. An apparatus of claim 13, wherein the apparatus is further caused to:
cause, at least in part, an association of one or more rules with the one or more groups,
wherein the one or more rules operate on the one or more contacts in the one or more groups.

15. An apparatus of claim 14, wherein the one or more rules relate, at least in part, to one or more notification settings, one or more reminder preferences, one or more availability statuses, one or more information sharing preferences, or a combination thereof.

16. An apparatus of claim 13, wherein the one or more groups include, at least in part, one or more family groups, one or more colleague groups, one or more neighbor groups, or a combination thereof

17. An apparatus of claim 11, wherein the apparatus is further caused to:
cause, at least in part, a prioritization, a sorting, an ordering, or a combination thereof of the one or more contacts based, at least in part, on the social proximity information.

18. An apparatus of claim 11, wherein the apparatus is further caused to:
determine a hierarchy of the one or more contacts based, at least in part, on the social proximity information.

19. An apparatus of claim 11, wherein the one or more contact details include, at least in part, a contact name, an address, a phone number, an electronic mail address, a social network name, or a combination thereof.

20. An apparatus of claim 11, wherein the apparatus is further caused to:
cause, at least in part, an appending of at least a portion of the one or more other contact details with at least another portion of the one or more contact details based, at least in part, on the social proximity information.

21.-48. (canceled)
